(19) United States
(12) Patent Application Publication
(10) Pub. No.: US 2024/0351104 A1
(43) Pub. Date: Oct. 24, 2024

(54) PROCESS AND PLANT FOR OBTAINING METAL POWDERS FOR BURNERS

(71) Applicant: Pometon SPA, Martellago (VE) (IT)

(72) Inventors: Ivan LORENZON, Martellago (VE) (IT); Ekaterina MAKAROVA, Martellago (VE) (IT); Giovanni BELLIN, Martellago (VE) (IT); Gianfranco VIDOTTO, Martellago (VE) (IT)

(21) Appl. No.: 18/701,728

(22) PCT Filed: Oct. 18, 2022
(86) PCT No.: PCT/IB2022/059997

§ 371 Date: Apr. 16, 2024

(30) Foreign Application Priority Data
Oct. 19, 2021 (IT) 102021000026837
Oct. 19, 2021 (IT) 102021000026843
Oct. 19, 2021 (IT) 102021000026849

(51) Int. Cl. B22F 9/22; B22F 9/04

(52) U.S. Cl. CPC B22F 9/22; B22F 9/04; B22F 2009/043; B22F 2201/013; B22F 2301/35; B22F 2998/10; B22F 2999/00

(57) ABSTRACT

A process for obtaining metal powders, preferentially iron powder, for burners to produce energy is described. The metal powders are obtained from metal oxide powders, preferentially iron oxide powders. The method comprises a step of preparing, during which the metal oxide powders, obtained during the combustion of the metal powders in burners, are prepared, a step of reduction, during which the metal oxide powders are reduced in a treatment chamber having an atmosphere comprising hydrogen and at a temperature of at least 900° C., preferentially at least 1000° C., obtaining reduced metal oxides, preferentially reduced iron oxides; and a step of pulverization, during which the reduced metal oxides are pulverized to obtain the metal powders.

### CROSS-REFERENCE TO RELATED APPLICATIONS

This Patent Application claims priority from Italian Patent Applications No. 102021000026843, No. 102021000026837 and No. 102021000026849 filed on Oct. 19, 2021, the entire disclosure of which is incorporated herein by reference.

### TECHNICAL FIELD

The present invention relates to a process for obtaining metal powders from metal oxide powders obtained by oxidation of metal powders within a burner to produce energy. Advantageously, the metal powders obtained by the process of the present invention are newly subjected to an oxidation in a burner to produce energy.

Advantageously, the present invention also relates to a plant for implementing a process for obtaining metal powders from metal oxide powders. Preferentially, the metal oxide powders are obtained by oxidation (combustion) of metal powders in a burner to produce energy.

### BACKGROUND

Recently, interest in the use of metal powders, preferentially iron powders, for energy generation has been noted. The metal powders are fed to burners in which the metal powders are burned, thereby creating energy. During the process, the metal powders are oxidized and metal oxide powders are obtained.

In the industry, there is a need to find processes and/or plants that allow to create a cycle that permits to process the metal oxide powders so as to obtain metal powders again that can be fed newly to burners.

### SUMMARY

Aim of the present invention is to provide a process and a plant, which make it possible to overcome, at least partially, the drawbacks of the prior art and meet the needs indicated above.

According to the present invention there are provided a process and a plant as claimed in the independent Claims below and, preferentially, in any one of the Claims that are dependent directly or indirectly on the independent Claim.

### BRIEF DESCRIPTION OF THE DRAWINGS

For a better understanding of the present invention, two preferred embodiments are described below, by way of non-limiting example only and with reference to the accompanying drawings, in which:

FIG. 1 schematically shows a plant in accordance with a first embodiment of the present invention, with parts removed for clarity;

FIG. 2 shows a diagram of a process in accordance with a first embodiment of the present invention;

FIGS. 3a to 3d show SEM images of metal powders, metal oxide powders and reduced metal oxides as present during the steps of the process according to FIG. 2;

FIG. 4 shows a diagram of a process in accordance with a second embodiment of the present invention;

FIG. 5 is a cross-sectional view of a plant in accordance with a second embodiment of the present invention, with parts removed for clarity;

FIG. 6a shows a portion of the plant of FIG. 5 in a first configuration, with parts removed for clarity;

FIG. 6b shows the portion of FIG. 6a in a second configuration, with parts removed for clarity;

FIG. 7 shows in enlarged view a detail of the portion of FIGS. 6a and 6b, with parts removed for clarity; and

FIG. 8 shows another portion of the plant of FIG. 5, with parts removed for clarity.

### DESCRIPTION OF EMBODIMENTS

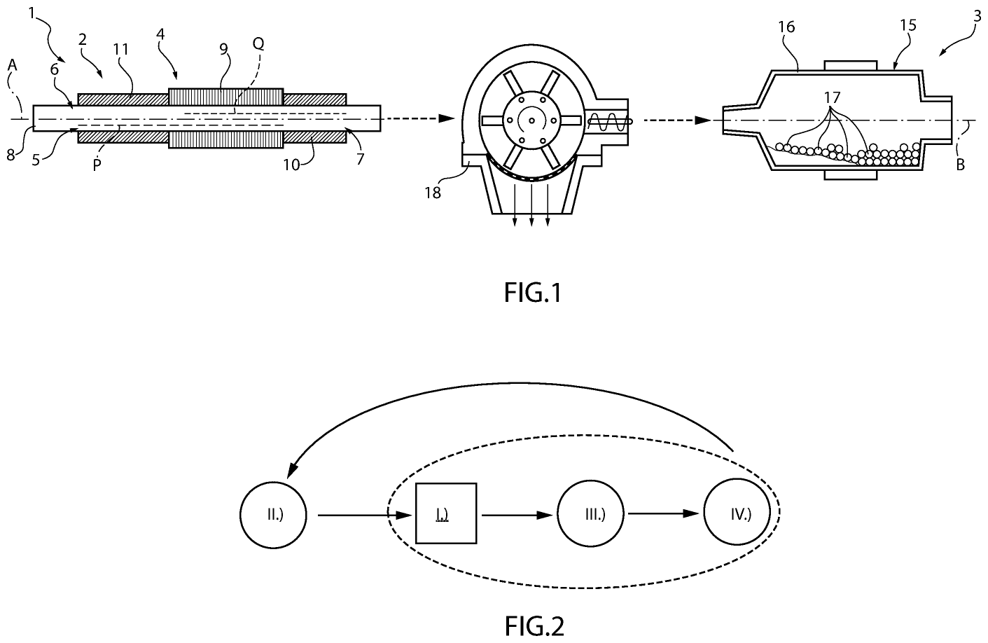

In FIG. 1, 1 schematically denotes, as a whole, a plant 1 for obtaining metal powders, preferentially iron powders, from metal oxide powders, preferentially from iron oxide powders.

Metal oxide powders can be obtained by oxidation (combustion) of metal powders in a burner to produce energy. Even more preferentially, the metal oxide powders are obtained by combustion of metal powders in the burner at temperatures of at least 900° C.

Advantageously, metal powders, preferentially iron powders, more preferentially before their first combustion, can present:
average dimensions (diameters), e.g. determined by Dynamic Light Scattering (DLS) or dry sieving, between 40 μm and 150 μm; and/or
an apparent volumetric mass between 2.00 g/cm³ and 5.00 g/cm³, preferentially between 2.5 g/cm³ and 3.5 g/cm³;
and/or an oxygen content not exceeding 1.6%.

Advantageously, the plant 1 is configured to allow obtaining metal oxide powders that can be newly burned and/or oxidized in the burner. In this way, the metal powders act as an energy carrier and a cycle can be obtained between the oxidation of the metal powders in the burner and the recovery of the metal powders from the metal oxide powders resulting from the combustion of the metal powders.

Referring to FIG. 1, the plant 1 comprises a furnace 2 configured to reduce the metal oxide powders in order to obtain reduced metal oxides. The plant 1 further comprises a pulverization apparatus 3 configured to pulverize the reduced metal oxides in order to obtain the metal powders.

The Applicant has observed experimentally that the reduced metal oxides (which in fact are nothing but non-oxidized metals) cannot be used efficiently if they are fed to the burner without further treatment. Therefore, a further treatment is required, namely the pulverization of the reduced metal oxides.

It should be noted that a distinction is made in this description, preferentially in order to distinguish the various steps of the processes of the treatment of the metal oxides, metal oxides, metals (i.e. non-oxidized metals) and reduced metal oxides. Reduced metal oxides result from a reduction of the metal oxides and, in fact, correspond to non-oxidized metals. However, the Applicant has found that in order to obtain non-oxidized metals that can be efficiently exposed to combustion again, it is necessary to obtain a further treatment, in particular a pulverization. Consequently, the use of the term reduced metal oxides indicates that these are non-oxidized metals that are not yet ready to be fed newly to the burner to produce energy, while the metals for the burners are obtained from the treatment of the reduced metal oxides.

As described in greater detail, according to the first embodiment, the reduction and the pulverization are obtained in two separate steps, whereas according to the second embodiment the two steps are executed simultaneously.

In greater detail, the metal oxides in the form of agglomerates of reduced metal oxides (i.e. agglomerates of non-oxidized metal oxides) exit from the furnace 2. Thanks to the pulverization apparatus 3, metal powders can be obtained that are suitable for being newly fed to the burner.

It should be noted that metal powders obtained after reduction and following the treatment in the pulverization apparatus 3, may have characteristics (for example dimensions, volumetric mass and/or oxygen content) that are different from those of the metal powders before their first combustion. However, it is possible to use the reduced (and pulverized) metal powders again for a combustion process.

In greater detail, the furnace 2 is configured to reduce the metal oxide powders at temperatures of at least 900° C., preferentially at least 1000° C., in an atmosphere comprising, preferentially consisting of, hydrogen and preferentially also nitrogen. Preferentially, the presence of hydrogen allows the reduction of the metal oxide powders.

Preferentially, the furnace 2 may comprise a plurality of zones at different temperatures. The furnace 2 is controlled so that the ratio of hydrogen to nitrogen can also reach 90% H₂ and 10% N₂ in the hottest zone(s).

In greater detail, the furnace 2 may comprise:
a treatment chamber 4, preferentially having a muffle, configured to contain the metal oxide powders;
a heating device (not shown) configured to heat, in use, at least a portion of an internal space 5 of the treatment chamber 4 to a temperature of at least 900° C., preferentially at least 1000° C.;
a conditioning device configured to introduce, in use, hydrogen and/or to maintain a desired concentration of hydrogen in the treatment chamber 4.

In further detail, the treatment chamber 4 may comprise an inlet 8 to allow the entry of the metal oxide powders into the treatment chamber 4 and an outlet 7 (distinct from the inlet 6) to allow the exit of the (agglomerates of the) reduced metal oxides from the treatment chamber 4.

More specifically, the treatment chamber 4 may extend along a longitudinal axis A from the inlet 6 to the outlet 7.

Preferentially, the furnace 2 may comprise a conveyor 8, preferentially a belt conveyor, configured to advance the metal oxide powders along a path P from the inlet 6 through the outlet 7 and the reduced metal oxides along a path Q and, preferentially outside the outlet 7.

In further detail, the treatment chamber 4 may comprise a main zone 9 and the heating device may be configured to heat the portion of the internal space 5 associated with the main 9 to a temperature of at least 900° C., zone preferentially at least 1000° C.

In addition, the treatment chamber 4 may comprise a cooling zone 10 arranged downstream of the main zone 9 (relative to the path P and/or to the path Q). Preferentially, in use, while the reduced metal oxides are advancing in the cooling zone 10, the reduced metal oxides may cool down.

The furnace 2 may comprise a cooling device for actively cooling the reduced metal oxides. Alternatively, cooling may be passive (i.e. no specific cooling device is present).

In addition, the treatment chamber 4 may also comprise a pre-heating zone 11 arranged upstream of the main zone 9 (relative to the path P and/or to the path Q). Preferentially, the pre-heating zone 11 differs from the main zone 9 in that it has a lower temperature than that of the main zone 9.

More specifically, the pre-heating zone 11 has temperature gradient.

In further detail, the heating device may comprise electrical resistors connected to the treatment chamber 4 for heating (indirectly) the internal space 5. Preferentially, the electrical resistors may be arranged outside the internal space 5. Even more preferentially, the electrical resistors can be connected to an external surface of the treatment chamber 4, the external surface facing another direction with respect to the internal space 5.

Preferentially, the electrical resistors are configured to ensure a temperature of at least 900° C., preferentially of at least 1000° C., in the portion of the internal space 5 associated with the main zone 9.

In greater detail, the conditioning device is configured to control the atmosphere (the gaseous composition) in the internal space 5, comprising, preferentially consisting of, hydrogen and nitrogen at desired concentrations by volume.

Preferentially, the conditioning device can be configured to control the hydrogen content so that it is at least 40% by volume, preferentially at least 50%, more preferentially at least 70%, in the portion of the internal space 5 associated with the main zone 9.

According to some preferred but non-limiting embodiments, the conditioning device may be configured to adjust the hydrogen content so that it is at least 90%, preferentially at least 95%, by volume in the portion of the internal space 5 associated with the main zone 9. In some examples, the conditioning device may be configured to adjust the hydrogen content so that it is at least 100% by volume in the portion of the internal space 5 associated with the main zone 9.

Even more preferentially, the conditioning device can be configured to adjust the ratio by volume of hydrogen (H₂) to nitrogen (N₂) between 40% H₂ and 60% N₂ to 90% H₂ and 10% N₂ in the portion of the internal space 5 associated with the main zone 9.

Preferentially, the hydrogen content can be as high as possible to favour the reduction of the metal oxide powders.

Advantageously, the conditioning device can also be configured to control an atmosphere containing hydrogen and nitrogen with less than 40% hydrogen in the zones of the treatment chamber 4 having temperatures lower than 900° C. (i.e., the zones of the treatment chamber 4 that are different from the main zone 9; in other words, the pre-heating zone 11 and the cooling zone 10).

Preferentially, the conditioning device is configured to adjust the composition of the atmosphere (of the gas) at the inlet 6 and at the outlet 7 so that the hydrogen concentration is lower than 30% by volume, preferentially lower than 20%, more preferentially lower than 10%.

Preferentially, the reduced metal oxides exit the furnace 2 in the form of agglomerates, preferentially sintered agglomerates, of reduced metal oxides.

With particular reference to FIG. 1, the pulverization apparatus 3 comprises at least a first pulverization device having:
a pulverization chamber 15, preferentially having and/or consisting of at least one cylindrical portion 16, rotatable around a rotation axis B and configured to receive the reduced (agglomerates of) metal oxides;
an actuating device configured to induce a rotation of the pulverization chamber 15 around the rotation axis A, preferentially at an angular speed between 10 rpm and 40 rpm, preferentially between 20 rpm and 40 rpm; and
a plurality of grinding bodies 17 (freely) arranged in the pulverization chamber 15, preferentially the cylindrical portion 16.

More specifically, the grinding bodies 17 are freely arranged in the pulverization chamber 15 so that the grinding bodies 17 can move into the pulverization chamber 15.

In greater detail, the grinding bodies 17 comprise and/or consist of grinding spheres. According to some non-limiting examples, the grinding spheres may have a diameter (e.g. determined by DLS or dry sieving) between 10 mm and 40 mm, preferentially between 15 mm and 35 mm, even more preferentially between 20 mm and 30 mm.

The grinding bodies 17 may comprise and/or may be of a ceramic material (e.g. silicon carbide) and/or alumina and/or steel and/or steel having nickel and/or chromium and/or titanium.

According to non-limiting embodiments, the some apparatus also comprises a fragmentation device 18 configured to fragment and/or crush the agglomerates of reduced metal oxides. Preferentially, the fragmentation device 18 is, in use, fed with the agglomerates of the reduced metal oxides from the furnace 2 and the agglomerates of the fragmented and/or crushed reduced metal oxides are inserted into the first pulverization device, preferentially into the pulverization chamber 15.

For example, the fragmentation device 18 may comprise a hammer mill and/or a crusher.

According to some embodiments, the furnace 2 and the pulverization apparatus 3 may be arranged at the same production site.

Alternatively, the furnace 2 and the pulverization apparatus 3 may be arranged at different production sites.

Furthermore, the first pulverization device and the fragmentation and/or crushing device 18 may be arranged at the same production site or different production sites.

It should be noted that the pulverization apparatus 3 can also treat agglomerates of reduced metal oxides obtained with processes that do not use the furnace 2.

In use, the furnace 2 makes it possible to obtain metal powders, preferentially iron powders, from metal oxide powders, preferentially from iron oxide powders. Preferentially, the metal powders that can be obtained from the operation of the furnace 2 are adapted to be fed newly to a burner in order to be burned to produce energy.

With reference to FIG. 2, the respective process (of operation of the furnace 2) comprises:
I.) a step of preparing, during which the metal oxide powders, preferentially metal oxide powders obtained during the combustion of the metal powders in a burner (II.), are prepared;
III.) a step of reduction, during which the metal oxide powders are reduced in the treatment chamber 4 having an atmosphere comprising hydrogen and at a temperature of at least 900 C, preferentially at least 1000 C, so as to obtain reduced metal oxides (non-oxidized metals), preferentially reduced iron oxides; and
IV.) a step of pulverization, during which the reduced (agglomerates of the) metal oxides are pulverized in order to obtain the metal powders, preferentially by means of the pulverization apparatus 3. In greater detail, during the step of preparing, the metal oxide powders are loaded into the and/or on the conveyor 8, preferentially on the belt conveyor.

During the step of reduction and with reference to the reduced iron oxide powders, the reduction follows the following scheme:

Fe₂O₃→Fe₃O₄→FeO→Fe

(Hematite→Magnetite→Wüstite→Iron)

Preferentially, during the step of reduction, the reduced metal oxides (non-oxidized metals) and water are formed.

According to the embodiment shown in FIG. 2, the step of pulverization can be executed subsequently to the step of reduction.

In greater detail, during the step of reduction, the metal oxide powders and/or the reduced metal oxides may advance along the path P and the path Q and through the treatment chamber 4, respectively. Preferentially, the metal oxide powders advance along the path P from the inlet 6 towards the outlet 7 and the reduced metal oxides, which form during the advancement of the metal oxide powders, advance along the path Q and outside the outlet 7.

Preferentially, one or more of the following sub-steps can be executed during the step of reduction:
a sub-step of heating, during which, at least the main zone 9 is heated, preferentially by means of the heating device, more preferentially by means of the electrical resistors, to a temperature of at least 900° C., preferentially of at least 1000° C.;
a sub-step of conditioning, during which the atmosphere of the internal space 5 is controlled, preferentially by means of the conditioning device, so that the atmosphere contains at least hydrogen, preferentially hydrogen and nitrogen; and
a sub-step of cooling, during which the reduced metal oxides are cooled, preferentially in the cooling zone 10.

More specifically, during the step of heating, the heating device can, preferentially the electrical resistors can, also heat the pre-heating zone 11, preferentially to a temperature lower than the temperature present in the main zone 9.

Preferentially, during the sub-step of conditioning, the conditioning device can introduce and/or maintain hydrogen and preferentially also nitrogen to obtain and/or maintain at least 40%, preferentially at least 50%, more preferentially at least 70%, by volume of hydrogen in the portion of the internal space 5 associated with the main zone 9.

According to some non-limiting embodiments, during the sub-step of conditioning, the conditioning device may introduce and/or obtain and/or maintain at least 90%, preferentially at least 95%, even more preferentially substantially 100%, of hydrogen in the main zone 9.

According to some non-limiting embodiments, during the sub-step of conditioning, the conditioning device may adjust the ratio by volume of hydrogen (H₂) to nitrogen (N₂) between 40% H₂ and 60% N₂ to 90% H₂ and 10% N₂ in the portion of the internal space 5 associated with the main zone 9.

Advantageously, during the sub-step of conditioning, the conditioning device can adjust (the composition of) an atmosphere (a gas), which contains hydrogen and nitrogen, in the zones of the treatment chamber 4 having temperatures below 900° C. (i.e., the zones of the treatment chamber 4 that are different from the main zone 9, for example the pre-heating zone 11) so that the hydrogen has a concentration of less than 40% by volume.

Preferentially, during the step of conditioning, the conditioning device can adjust the composition of the atmosphere at the inlet 6 and at the outlet 7 so that the hydrogen is less than 30%, preferentially less than 10%, by volume.

In addition, the process may also comprise a step of transferring, during which the reduced metal oxides are transferred into the pulverization chamber 15, in which the plurality of grinding bodies 17 are arranged.

Preferentially, an amount of the reduced (agglomerates of the) metal oxides is transferred during the step of transferring so that the ratio by weight between the grinding bodies and the reduced metal oxides and/or the metal oxide powders is between 2 to 15, preferentially between 5 to 10.

During the step of pulverization, a sub-step of rotating can be executed, preferentially executed subsequent to the step of transferring, and during which the pulverization chamber 15, preferentially the cylindrical portion 16, rotates around the rotation axis B. During the rotation, the grinding bodies 17 grind the reduced metal oxides so as to obtain the metal powders.

Preferentially, during the sub-step of rotating, the pulverization chamber 15, preferentially the cylindrical portion 16, rotates at an angular speed between 10 rpm to 40 rpm, preferentially between 20 rpm to 30 rpm.

More specifically, the sub-step of rotating is executed for at least 30 minutes.

Preferentially, during the sub-step of rotating, the ratio by weight between the grinding bodies 17 and the reduced (agglomerates of the) metal oxides may be between 2 to 15, preferentially between 5 to 10.

According to some non-limiting preferred embodiments, the process may also comprise a step of pre-treatment, executed prior to the step of transferring, and during which the reduced (agglomerates of) metal oxides may be fragmented and/or crushed, preferentially by means of the fragmentation device 18, even more preferentially by means of the hammer mill and/or a crusher. Following the step of pre-treatment and during the step of transferring, the reduced (agglomerates of) metal oxides are introduced into the pulverization chamber 15.

According to some alternative embodiments, the step of transferring can be executed without executing further steps of pre-treatment; i.e., the reduced (agglomerates of) metal oxides obtained during the step of reduction, are inserted into the pulverization chamber 15 without further handling of the reduced (agglomerates of) metal oxides. For example, according to such an embodiment, the reduced metal oxides may be transferred during the step of transferring directly from the treatment chamber 4 into the pulverization chamber 15.

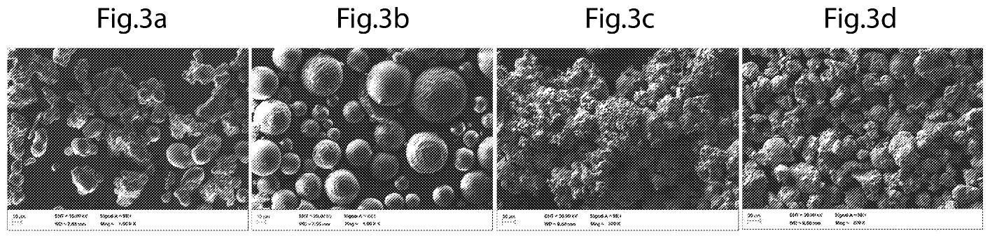

Representative SEM images are shown in FIGS. 3a to 3d. FIG. 3a shows an image obtained from a sample of iron powders before combustion (i.e. before the execution of a first step II.); in other words, before a first combustion of the metal powders). FIG. 3b shows an image obtained from a sample of iron oxide powders obtained during the combustion of the iron powders (i.e. during the execution of step II.)). FIG. 3c, shows an image obtained from a sample of an agglomerate of reduced iron oxides following the step of reduction (step I.)) and before the step of pulverization (step III.)). FIG. 3d shows the result after the step of pulverization (IV.)). It can be noted that the metal powders obtained during the step of reduction and the step of pulverization (FIG. 3d) differ from those that have never been subjected to combustion (FIG. 3a). However, also the metal powders obtained during the step of reduction and the step of pulverization (FIG. 3d) are adapted to generate energy inside a burner (through the combustion thereof).

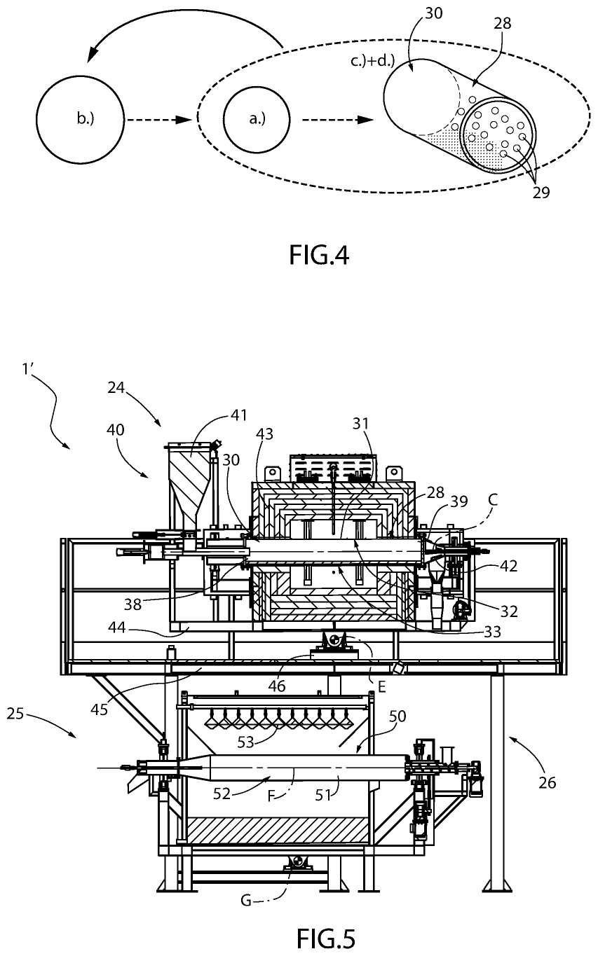

With particular reference to FIG. 5, the number 1′ denotes a second embodiment of a plant in accordance with the present invention. With reference to FIG. 4, the plant 1′ is configured to execute a process in accordance with a second embodiment of the present invention. The process of the embodiment of FIG. 3 differs from the process of the embodiment of FIG. 2 in that the step of reduction and the step of pulverization are executed simultaneously.

With reference to FIG. 5, the plant 1′ comprises a furnace 24 configured to simultaneously reduce and pulverize the metal oxide powders so as to obtain the metal powders.

The plant 1′ may also comprise a post-treatment apparatus 25 configured to receive the metal powders from the furnace 24 and to subject the metal powders to a post-treatment.

Preferentially, the plant 1′ may also comprise a support frame 26 configured to support at least the furnace 24, and preferentially also at least partially the post-treatment apparatus 25.

Preferentially, the support frame 26 may be configured to lift the furnace 24 above the post-treatment apparatus 25. Preferentially, the furnace 24 may be placed above the post-treatment apparatus 25 along a vertical axis. This allows the furnace 24 and the post-treatment apparatus 25 to be placed in a space-saving manner.

Alternatively, the furnace 24 and the post-treatment apparatus 25 may be arranged horizontally, and preferentially one after the other.

As explained in more detail below, the shown configuration of the furnace 24 and of the post-treatment apparatus 25 allow to facilitate the transfer of the metal powders from the furnace 24 to the post-treatment apparatus 25.

Preferentially, the support frame 26 may extend and/or may be configured to extend from a (substantially) horizontal support surface of a production site.

Preferentially, the plant 1′ may also comprise a control device operatively connected to and configured to control the operation of the furnace 24 and preferentially also of the post-treatment apparatus 25.

Preferentially, the control device can be configured to command the furnace 24 so as to induce (in particular, simultaneously) a reduction and a pulverization of the metal oxide powders in order to obtain metal powders.

In greater detail, the control device may be configured to command the furnace 24 in a pulverization configuration (see FIGS. 5, 6a and 7) to reduce and pulverize the metal oxide powders simultaneously in order to obtain the metal powders.

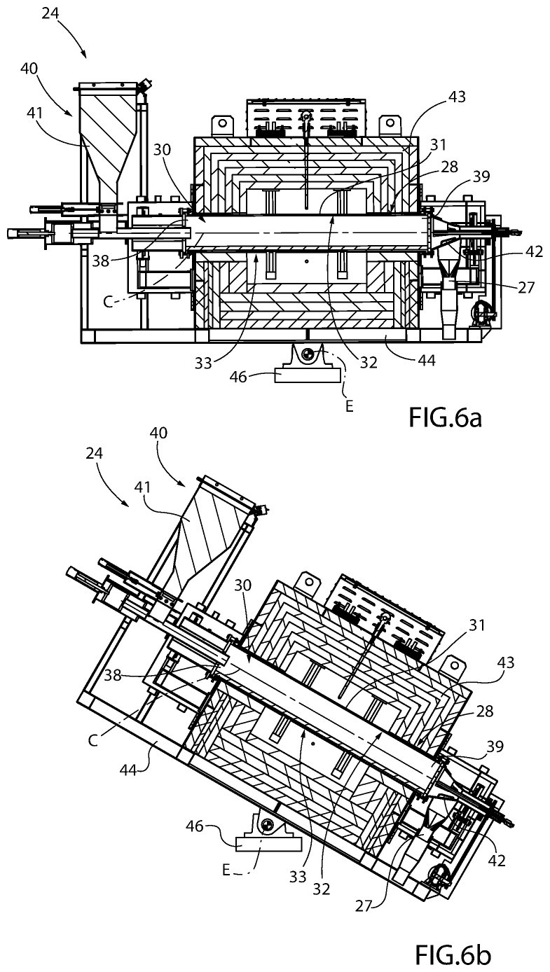

Preferentially, the control device may also be configured to command the furnace 24 in a loading configuration in which insertion of the metal oxide powders into the furnace 24 is allowed and/or in an unloading configuration (see FIG. 6b) in which the metal powders can be unloaded and/or transferred from the furnace 24.

Preferentially, in use, the control device is configured to command the furnace 24 first in the loading configuration, subsequently in the pulverization configuration, and finally in the unloading configuration.

The plant 1′ may further comprise a transfer device 27 configured to allow the transfer of the metal powders from the furnace 24 to the post-treatment apparatus 25.

In greater detail and with particular reference to FIGS. 5 to 6b, the furnace 24 may comprise:
a treatment chamber 28 rotatable around a first rotation axis C and configured to contain the metal oxide powders to be transformed into metal powders;
a first actuator device, e.g. an electric motor, configured to rotate the treatment chamber 26 around the rotation axis C;
a plurality of grinding bodies 29 (freely) arranged in an internal space 30 of the treatment chamber 26;
a heating device configured to heat, in use, the internal space 30 of the treatment chamber 28 to a temperature of at least 900° C., preferentially at least 1000° C.;
a conditioning device configured to introduce, in use, hydrogen and/or to maintain a desired concentration of hydrogen in the treatment chamber 28, preferentially in the internal space 30.

In addition, the treatment chamber 28 may also be angularly movable around a second rotation axis E transverse, preferentially perpendicular, to the first rotation axis C.

The furnace 24 may comprise a second actuator device configured to induce an angular movement of the treatment chamber 28 around the second rotation axis E.

Preferentially, the first actuator device is configured to induce a (continuous 360°) rotation of the treatment chamber 28 around the first rotation axis C, preferentially at an angular speed between 10 rpm to 40 rpm, preferentially between 20 rpm to 30 rpm, while the furnace 24 is commanded, in use, in the pulverization configuration.

Furthermore, the second actuator device may be configured to induce an undulating movement (angular movement), preferentially executed at the same time as the rotation around the first rotation axis C, the second rotation axis E while the furnace 24 is commanded in the pulverization configuration.

Preferentially, during the undulating movement an angular position of the treatment chamber 28 relative to the second rotation axis E varies between a first limit value greater than −90°, preferentially greater than −60°, even more preferentially greater than −45°, and lower than 0°, and a second limit value lower than 90°, preferentially lower than 60°, even more preferentially lower than 45°, and greater than 0°.

For example, the first limit value may be −2° and the second limit value may be 2°.

In further detail, the treatment chamber 28 may comprise, preferentially may consist of, a cylindrical portion 31 having the internal space 29.

Preferentially, the cylindrical portion 31 may extend along the first rotation axis C; that is, the first rotation axis C may define a longitudinal axis of the cylindrical portion 31. More preferentially, the first rotation axis C may be coaxial with a central axis of the cylindrical portion 31 and/or may define a mirror axis of the cylindrical portion 32.

Advantageously, the treatment chamber 28, preferentially the cylindrical portion 31, can comprise and/or can be made of a steel, preferentially having chromium and titanium, of a ceramic material, such as for example silicon carbide, alumina, zirconia, in any combination thereof and/or in others. Preferentially, at least one internal surface 33 (facing the internal space 30) of the treatment chamber 28, preferentially the cylindrical portion 31, may comprise a steel, preferentially having chromium and titanium, a ceramic material, such as for example silicon carbide, alumina, zirconia, any combination thereof and/or others.

Advantageously, an internal surface 33 (facing the internal space 30) of the treatment chamber 28, can comprise and/or can be made of a material that remains oxidized during the reduction of the metal oxide powders, preferentially even if the reduction takes place in an atmosphere with a high hydrogen content (hydrogen content (in the internal space 30) of at least 90%).

In greater detail, the grinding bodies 29 may be made of a material comprising a ceramic material (such as, for example, silicon carbide) and/or alumina and/or steel containing nickel and/or chromium and/or titanium.

Advantageously, the grinding bodies 29 may comprise, preferentially consist of, grinding spheres. According to some non-limiting embodiments, the grinding spheres may have a diameter between 10 mm and 40 mm, preferentially between 15 mm and 35 mm, even more preferentially between 20 mm and 30 mm.

Preferentially, in use, the ratio by weight between the grinding bodies 29 and the metal oxide powders may be between 2 to 15, preferentially between 5 to 10.

In further detail, the device for heating the furnace 24 may comprise electrical resistors connected to the treatment chamber 28, preferentially the cylindrical portion 31, for heating (indirectly) the internal space 30. Preferentially, the electrical resistors may be arranged outside the internal space 30. Even more preferentially, the electrical resistors may be connected to an external surface 33 of the treatment chamber 28. The external surface 33 being facing in a different direction with respect to the internal space 30.

Preferentially, the electrical resistors are configured to ensure a temperature of at least 900° C., preferentially of at least 1000° C., in the internal space 30.

In greater detail, the conditioning device is configured to adjust the atmosphere in the internal space 30 so that the atmosphere comprises, preferentially consists of, hydrogen. According to some non-limiting embodiments, the conditioning device may be configured to adjust the atmosphere in the internal space 30 so that the atmosphere comprises, preferentially consists of, hydrogen and nitrogen at desired volumetric concentrations.

Preferentially, the conditioning device may be configured to adjust the hydrogen content (in the internal space 30) so that it is at least 40%, preferentially at least 50%, more preferentially at least 70%, by volume. According to some non-limiting embodiments, the conditioning device may be configured to adjust the hydrogen content (in the internal space 30) so that it is at least 90%, preferentially at least 95%, by volume. According to some non-limiting examples, the conditioning device may be configured to control the hydrogen content (in the internal space 30) so that it is 100% by volume.

According to some non-limiting embodiments, the conditioning device may be configured to adjust the ratio by volume of hydrogen (H₂) to nitrogen (N₂) so that it varies from 40% H₂ and 60% N₂ to 90% H₂ and 10% N₂ or 95% H₂ and 5% N₂ in the internal space 30.

Preferentially, the treatment chamber 29, preferentially the cylindrical portion 31, may comprise an inlet configured to allow the entry, preferentially by means of a rotating joint, of the hydrogen and/or of the nitrogen into the internal space 29 and preferentially an outlet configured to allow the exit of the hydrogen and/or of the nitrogen and/or of the water formed during the reduction of the metal oxide powders, from the internal space 30.

Preferentially, the treatment chamber 28 may comprise a feed inlet to allow the metal oxide powders to be introduced into the internal space 30 and an outlet opening to allow the metal powders to escape from the internal space 30.

Preferentially, the feed inlet and the outlet opening may be arranged at respectively a first end 38 of the cylindrical portion 31 and at a second end 39 of the cylindrical portion 31 opposite the first end 38.

With particular reference to FIGS. 5 to 6b, the furnace 24 may comprise a feed device 40, preferentially having a hopper 41 and a loading piston, configured to feed (in a controlled manner) the metal oxide powders into the treatment chamber 28, preferentially into the internal space 30, preferentially through the feed inlet.

Preferentially, the furnace 24 may also comprise a retaining element, preferentially a perforated metal sheet, arranged at the outlet opening configured to let the metal powders pass and to retain the grinding bodies 29 in the internal space 30.

Preferentially, while the furnace 24 may be controlled in the loading configuration, the treatment chamber 28 and/or the first rotation axis C has a (substantially) horizontal orientation.

Preferentially, while the furnace 24 is brought into the unloading configuration, the treatment chamber 28 is brought into an unloading position, in which the first rotation axis C is inclined (relative to a horizontal axis). Preferentially, when the treatment chamber 28 is in the unloading position, the feed inlet is raised with respect to the outlet opening (i.e., the outlet opening is interposed between the feed inlet and the support surface). In this way, the escape of the metal powders from the internal space 30 is facilitated, preferentially using gravitational force.

Preferentially, the second actuator device can be configured to move angularly the treatment chamber 28 around the second rotation axis E in the unloading position to facilitate and/or allow the unloading of the metal powders from the internal space 30.

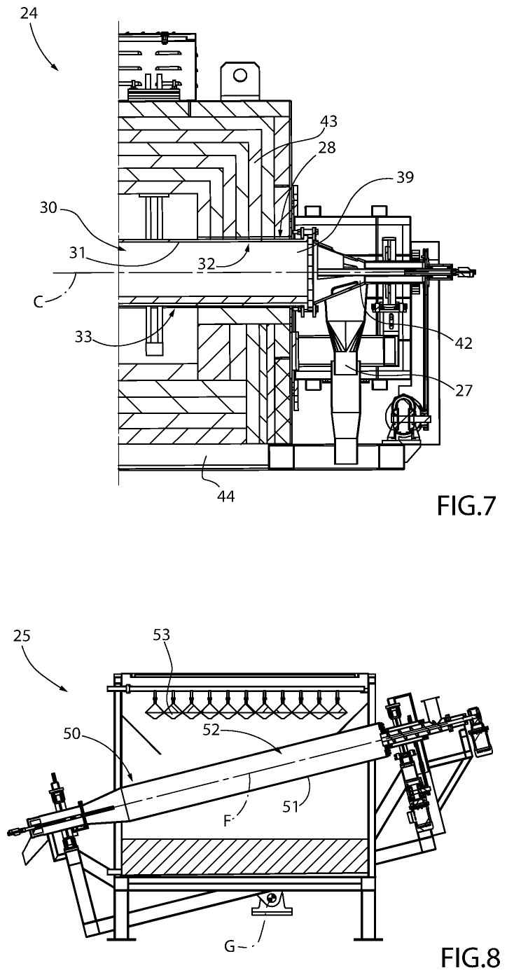

With particular reference to FIG. 7, the furnace 24 may also comprise a rotary unloading element 42 connected to the treatment chamber 28 at the outlet opening to further facilitate unloading the metal powders.

According to some non-limiting embodiments, the outlet opening and/or the unloading element 42 may define a portion of the transfer device 27.

With particular reference to FIGS. 5 to 6b, the furnace 24 may also comprise an isolation device 43 (at least partially) arranged around the treatment chamber 28 to isolate the treatment chamber 28 thermally from an external environment. Preferentially, the treatment chamber 28 is (at least partially) placed within the isolation device 43.

The furnace 24 may also comprise a support structure 44 that carries the treatment chamber 28 and preferentially also the isolation device 43 and/or the feed device 40.

More specifically, the support structure 44 may in turn be carried by the support frame 26. Preferentially, the support structure 44 may be connected to a horizontal wall 45 of the support frame 44.

Preferentially, the support frame 26 may comprise a coupling element 46 (connected to the horizontal wall 45 e) angularly movably carrying the support structure 45. Preferentially, the support structure 45 may be angularly movable around the second rotation axis E (i.e., the coupling between the coupling element 46 and the support structure 44 defines the second rotation axis E).

Furthermore, the second actuating device may be configured to induce an angular movement of the support structure 44 around the second rotation axis E to angularly move the treatment chamber 28 around the second rotation axis E.

With particular reference to FIGS. 5 and 8, the post-treatment apparatus 25 may comprise:
a post-treatment chamber 50, preferentially having a cylindrical portion 51, rotatable around a third rotation axis F;
a third actuator device configured to induce a rotation of the post-treatment chamber 50, preferentially of the cylindrical portion 51, around the third rotation axis F;
a plurality of auxiliary grinding bodies arranged in an internal space 52 of the post-treatment chamber 50, preferentially of the cylindrical portion 51.

Advantageously, the post-treatment chamber 50, preferentially the cylindrical portion 51, is angularly movable around a fourth rotation axis G transverse, preferentially perpendicular, to the third rotation axis F and the post-treatment apparatus 25 can comprise a fourth actuator device configured to induce an angular movement of the post-treatment chamber 50 around the fourth rotation axis G.

Preferentially, during the operation of the post-treatment apparatus 25 (i.e. during the execution of a step of post-treatment):
the third actuator device induces a (continuous 360°) rotation of the post-treatment chamber 50 around the third rotation axis F, preferentially at an angular speed between 10 rpm and 40 rpm, preferentially between 20 rpm and 30 rpm; and
preferentially, the fourth actuator device induces an undulating movement (an angular movement) of the post-treatment chamber 50 around the fourth rotation axis G.

Furthermore, the fourth actuator device may be configured to move the post-treatment chamber 50 around the fourth rotation axis G to a loading position (see FIG. 8) when the treatment chamber 28 is, in use, in the unloading position. Preferentially, the post-treatment chamber 50 may be inclined relative to a horizontal axis when it is in the loading position.

Preferentially, the treatment chamber 28 may be arranged above the post-treatment chamber 50. Alternatively, the post-treatment chamber 50 may be displaced laterally with respect to the treatment chamber 28.

Preferentially, the auxiliary grinding bodies comprise and/or consist of auxiliary grinding spheres having a diameter between 10 mm and 40 mm, preferentially between 15 mm and 35 mm, even more preferentially between 20 mm and 30 mm.

Preferentially, the auxiliary grinding bodies are made of a material comprising steel.

Preferentially, in use, the post-treatment of the metal powders in the post-treatment chamber 50 allows to keep detached and/or further fragment the metal powders.

Preferentially, the transfer device 27 may be configured to allow the transfer of the metal powders from the internal space 30 to the internal space 52.

Preferentially, the post-treatment chamber 50 may comprise an inlet for receiving the metal powders and/or an outlet for allowing the exit of the metal powders.

According to some non-limiting embodiments, the inlet of the post-treatment chamber 50 may define another portion of the transfer device 27.

Preferentially, when the furnace 24 is (brought to—adjusted) in the unloading configuration and the post-treatment chamber 50 is (brought to—adjusted) in the loading position, the outlet opening and the inlet may be aligned and/or connected to each other.

In some non-limiting alternative embodiments, the transfer device 27 may comprise a transfer tube configured to connect the outlet opening with the inlet of the post-treatment chamber 50.

Preferentially, the post-treatment apparatus 25 may also comprise a cooling device 53 to cool the metal powders, preferentially by cooling the post-treatment chamber 50 and the internal space 52.

More specifically, the cooling device 53 may be configured to direct a cooling fluid onto the post-treatment chamber 50.

In use, the plant 1′ makes it possible to obtain metal powders from the metal oxide powders. The metal powders obtained by means of the plant 1′ are similar to those shown in FIG. 3d.

The process to be implemented by means of the plant 1′ to obtain metal powders from the metal oxide powders differs from the previously described process in that the step of reduction and the step of pulverization are executed at the same time. In fact, the furnace 24, preferentially the treatment chamber 28, makes it possible to reduce the metal oxide powders into reduced metal oxides and to grind (the metal oxide powders and) the reduced metal oxides at the same time.

In greater detail, during the step of reduction and the step of pulverization (executed simultaneously) (the furnace 24 is in the pulverization configuration), a sub-step of rotating is executed, during which the treatment chamber 28 rotates around the rotation axis C.

Preferentially, during the sub-step of rotating, the first actuating device induces the rotation of the treatment chamber 28 around the first rotation axis C, preferentially at an angular speed from 10 rpm to 40 rpm, preferentially between 20 rpm and 30 rpm.

Preferentially, during the step of reduction and the step of pulverization, a sub-step of undulation may also be executed during which the treatment chamber 28 undulates (executes an angular movement) around the second rotation axis E. Preferentially, during the sub-step of undulation, the treatment chamber 28 moves angularly between an angular position corresponding to the first limit value and an angular position corresponding to the second limit value.

More specifically, during the sub-step of undulation, the second actuator device may move angularly the treatment chamber 28, preferentially by angular movement of the support structure 44, around the second rotation axis E.

During the step of reduction and the step of pulverization, a temperature of at least 900° C., preferentially of at least 1000° C., is maintained in the internal space 30, preferentially thanks to the operation of the heating device.

Furthermore, during the step of reduction and the step of pulverization, a desired concentration by volume of hydrogen and preferentially also of nitrogen is also introduced and/or maintained by means of the conditioning device. Preferentially, in the internal space 30, the hydrogen content is at least 40% by volume, preferentially at least 50%, more preferentially at least 70%. Even more preferentially, in the internal space 30, the hydrogen content is at least 90% by volume, preferentially at least 95%, more preferentially substantially 100%.

According to some embodiments, during the step of reduction and the step of pulverization, the conditioning device adjusts a ratio by volume of hydrogen (H₂) to nitrogen (N₂) so that said ratio is from 40% H₂ and 60% N₂ to 90% H₂ and 10% N₂ or 95% H₂ and 5% N₂ in the internal space 30.

Preferentially, the step of reduction and the step of pulverization are executed for at least 30 minutes.

The method may also comprise a step of loading, during which the metal oxide powders are loaded, preferentially by means of the feed device 40, into the treatment chamber 28, preferentially into the internal space 30. Preferentially, an amount of metal oxide powders is loaded during the step of loading so that the ratio by weight between the grinding means 29 and the metal oxide powders can vary between 2 and 15, preferentially between 5 and 10.

Preferentially, the process may also comprise a step of transferring, preferentially executed subsequently to the step of reduction and the step of pulverization, during which the metal powders are transferred from the treatment chamber 28 into the post-treatment chamber 50.

Alternatively, the metal powders may be removed from the treatment chamber 28 subsequently to the step of reduction and to the step of pulverization without transfer into the post-treatment chamber 50.

In greater detail, during the step of transferring, the second actuator device induces an angular rotation of the treatment chamber 28 to place it in the unloading position. Preferentially, the post-treatment chamber 50 is placed in the loading position by actuating the fourth actuator device.

Preferentially, the process may also comprise one or more of the following steps:
an auxiliary step of pulverization, during which the metal powders are further pulverized (in the post-treatment chamber 50); and/or
a step of cooling, during which the metal powders are cooled (in the post-treatment chamber 50 and/or in the treatment chamber 28).

Preferentially, the auxiliary step of pulverization and the step of cooling are executed simultaneously and subsequently to the step of transferring and while the metal powders are in the post-treatment chamber 50.

Preferentially, during the auxiliary step of pulverization, the post-treatment chamber 50 rotates around the third rotation axis E (by actuation of the rotation by the third actuator device), and preferentially the post-treatment chamber 50 is also subjected to an undulating movement (angular movement) around the fourth rotation axis G (and thanks to the operation of the fourth actuator device).

Preferentially, during the step of cooling a cooling fluid can be directed to the post-treatment chamber 50.

The process may also comprise a step of unloading that is executed subsequently to the auxiliary step of pulverization and/or to the step of cooling.

Thanks to the process, the metal powders obtained by the process can be fed newly to a burner for the combustion thereof.

From an examination of the characteristics of the processes and/or of the plant 1 and/or of the plant 1′ according to the present invention, the advantages that it allows to obtain are evident.

Preferentially, it is possible to recover the metal powders that can be burned again in a burner to produce energy.

One advantage lies in the possibility of using at least partially energy resulting from renewable sources to transform metal oxide powders into metal powders. In this way, metal powders act as an energy carrier and/or accumulator.

Finally, it is clear that modifications and variations may be made to the processes and/or to the plant 1 and/or to the plant 1′ described and shown herein that do not go beyond the scope of protection defined by the Claims.

1-14. (canceled)

15. A process for obtaining metal powders for burners to produce energy; metal powders being obtained from metal oxide powders; the process comprising:
a step of preparing, during which the metal oxide powders obtained during the combustion of the metal powders in burners, are prepared;
a step of reduction, during which the metal oxide powders are reduced in a treatment chamber having an atmosphere comprising hydrogen and at a temperature of at least 900° C., obtaining reduced metal oxides; and
a step of pulverization, during which the reduced metal oxides are pulverized in order to obtain metal powders.

16. The process according to claim 15, wherein the step of reduction and the step of pulverization are executed simultaneously in the treatment chamber.

17. The process according to claim 16, wherein a plurality of grinding bodies are placed in the treatment chamber; and
wherein during the step of reduction and the step of pulverization, the treatment chamber rotates around a rotation axis.

18. The process according to claim 16, further comprising:
a step of transferring, during which the metal powders are transferred from the treatment chamber into a post-treatment chamber;
an auxiliary step of pulverization, during which the metal powders are newly pulverized; and/or
a step of cooling, during which the metal powders are cooled.

19. The process according to claim 18, wherein the auxiliary step of pulverization and the step of cooling are executed simultaneously subsequently to the step of transferring and while the metal powders are present in the post-treatment chamber.

20. The process according to claim 15, wherein the step of pulverization is executed subsequently to the step of reduction.

21. The process according to claim 20, further comprising:
a step of transferring, during which the reduced metal oxides are transferred into a pulverization chamber in which a plurality of grinding bodies are placed; and
the step of pulverization includes a sub-step of rotating, executed subsequently to the step of transferring, and during which the pulverization chamber rotates around a rotation axis and during the rotation the reduced metal oxides are ground by the grinding bodies.

22. The process according to claim 20, wherein, during the step of reduction, the metal oxide powders and/or the reduced metal oxides advance along a path and through the treatment chamber.

23. The process according to claim 17, wherein at least one of:
the plurality of grinding bodies include grinding spheres exhibiting a diameter between 10 mm to 40 mm;
a ratio by weight between the plurality of grinding bodies, on the one hand, and the reduced metal oxides and/or the metal oxide powders, on the other hand, is between 2 to 15; or
the plurality of grinding bodies are made of a material including a ceramic material and/or alumina and/or steel having nickel and/or chromium and/or titanium.

24. A plant for obtaining, from metal oxide powders, metal powders, preferentially iron powders, for burners to produce energy; the plant being configured and/or programmed to execute the process according to claim 15.

25. The plant according to claim 24, further comprising a furnace configured to reduce the metal oxide powders in order to obtain reduced metal oxides and a pulverization apparatus configured to pulverize the reduced metal oxides in order to obtain metal powders.

26. The plant according to claim 24, further comprising:
at least one furnace having:
a treatment chamber rotatable around a first rotation axis and configured to contain metal oxide powders to be transformed into metal powders;
a first actuator device configured to induce a rotation of the treatment chamber around the first rotation axis;
a plurality of grinding bodies arranged in the treatment chamber;
a heating device configured to heat, in use, an internal space of the treatment chamber to a temperature of at least 900° C.;
a conditioning device configured to introduce, in use, hydrogen and/or maintain a desired concentration of hydrogen in the treatment chamber; and
a control device is operatively connected to the furnace and configured to control the furnace so as to induce a reduction and a pulverization of the metal oxide powders to obtain metal powders.

27. The plant according to claim 26, wherein at least the treatment chamber is angularly movable around a second rotation axis transverse, perpendicular, to the first rotation axis;
the at least one furnace includes a second actuator device configured to induce an angular movement of the treatment chamber around the second rotation axis;
the control device is configured to command the furnace in a pulverization configuration to reduce and pulverize metal oxide powders to obtain metal powders;
the first actuator device induces, in use, a rotation of the treatment chamber around the first rotation axis and the second actuator device induces, in use, an undulating movement around the second rotation axis when the furnace is commanded in the pulverization configuration;
the control device is configured to command the furnace into an unloading configuration; wherein the second actuator device is configured to angularly move the treatment chamber around the second rotation axis to an unloading position to facilitate and/or allow unloading of the metal powders from the treatment chamber.

28. The plant according to claim 26, further comprising a post-treatment apparatus having:
a post-treatment chamber rotatable around a third rotation axis;
a third actuator device configured to actuate a rotation of the post-treatment chamber around the third rotation axis; and
a plurality of auxiliary grinding bodies arranged in the post-treatment chamber;
a transfer device configured to allow the transfer of metal powders from the treatment chamber to the post-treatment chamber;
the post-treatment apparatus includes a cooling device for cooling the post-treatment chamber and/or an internal space of the post-treatment chamber and/or the metal powders;
the treatment chamber is arranged above the post-treatment chamber.

29. The plant according to claim 24, wherein:
the plurality of grinding bodies include grinding spheres exhibiting a diameter between 10 mm to 40 mm; and/or
the plurality of grinding bodies are made of a material comprising a ceramic material and/or alumina and/or steel having nickel and/or titanium.
